(19) United States
(12) Patent Application Publication
(10) Pub. No.: US 2003/0074267 A1
(43) Pub. Date: Apr. 17, 2003

(54) METHOD AND SYTEM FOR INTEGRATED ONLINE AND BRICK AND MORTAR PROVIDER SHOPPING

(76) Inventors: Kamal Acharya, Los Altos, CA (US); Vincent Tong, Alameda, CA (US); Peter Gremett, Sunnyvale, CA (US); Matthew Crampton, Mountain View, CA (US); Srinivas Lingutla, Pittsfield, MA (US); Ellen F. Butler, San Francisco, CA (US)

Correspondence Address: GLENN PATENT GROUP, 3475 EDISON WAY, SUITE L, MENLO PARK, CA, 94025, US

(21) Appl. No.: 09/975,831

(22) Filed: Oct. 11, 2001

(51) Int. Cl. G06F 17/60

(52) U.S. Cl. 705/26

(57) ABSTRACT

The method and system of the present invention provides a comparison shopping experience that enables online shoppers to shop online confidently and conveniently, knowing that they are getting the best deal for a product/service based on online comparison information about both online and offline providers of a product/service. The system and method of the present invention provides a multi-channel search result, an integrated list of online and offline providers, and comparison information about providers of a selected product or service. Thus, the system and method of the present invention saves shopping time for bargain-seeker shoppers, attracts more physical product/service retail outlets to join online shopping services, and retains the existing online product/service providers.

### BACKGROUND OF THE INVENTION

1. Field of the Invention

The invention relates to online shopping. More particularly, the invention relates to a system and a family of methods that provide for online shopping of a product or service from both online and offline providers.

2. Description of Related Technology

Presently, online shopping services provide information about only online product/service providers that have a storefront Web access, which usually do not have a physical retail store. Such information does not include comparison information about providers of a product/service based on information received from both online and offline providers. Therefore, bargain-seeker shoppers do not fully trust current online product/service pricing information, and majority of shoppers end up using the information they receive from online searching to local physical retail providers for final price comparison. Often, such bargain-seeker shoppers get a better deal or competitive price from a local physical provider and eventually do the shopping offline. Local physical retail providers further attract shoppers because they provide in-store product touch and feel experience, quick delivery and pickup, and convenient return policies.

Furthermore, current online shopping services do not give detailed information about offline providers, such as in-store pick up policies, in-store return policies, and other detailed information.

There is a need, therefore, for online shopping services that provide shoppers with the ability to find the most competitive price for product/service and comparison information about online and offline providers of such product/service, all in one integrated search. There is also a need for online shopping services that attract and retain offline product/service providers by highlighting their detailed information and features online.

### SUMMARY OF THE INVENTION

One presently preferred embodiment of the invention provides a system and a method for providing an integrated electronic list of providers for a product or service that comprises the steps of determining at least one online provider, determining at least one offline provider, and integrating the at least one online service provider with the at least one offline service provider to provide an integrated list of providers.

Another presently preferred embodiment of the invention provides a system and a method for providing online comparison information about at least one online provider and at least one offline provider of a product or service. The comparison information may also include comparison information about the offline providers of the product or service.

### BRIEF DESCRIPTION OF THE DRAWINGS

FIG. 1 shows a flow chart for online shopping according to one embodiment of the present invention;

FIG. 2 shows a representation of a search result according to one embodiment of the present invention; and

FIG. 3 shows a representation of an exemplary system for providing integrated shopping information.

### DETAILED DESCRIPTION OF THE INVENTION

The invention contemplates a new and unique system and a family of methods for online shopping, which may be implemented in a network of computer systems, such as the Internet.

Online shoppers may include those shoppers who both search and shop a product or service online. These shoppers usually do not check the online price information with the price information offered by local product/service providers for getting a bargain price. One the other hand, online shoppers may also include those bargain-seekers, price-driven shoppers who usually take the information they receive from online search results to offline local providers, looking for a better deal and/or special offers, sales, and/or coupons. Therefore, current online shopping services lose revenue unless they provide an integrated list of both online and offline product/service providers in response to a search for a product/service, as will be discussed below.

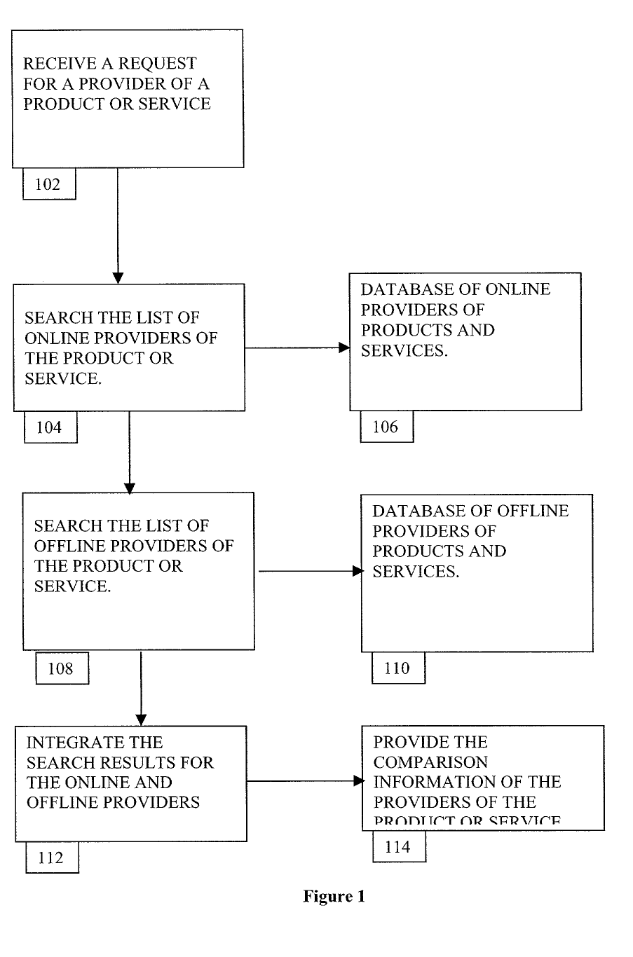

FIG. 1 shows a block diagram representation of a method of online search process according to a preferred embodiment of the invention. A shopper may request an online search for a product or service, in step 102. A shopper may request for a product/service search based on a category of products/services, such as toys, electronics, or cleaners. A shopper may also request for a product/service based on a name or an identification code of a specific product or service, such as a game, a television set, or a carpet cleaner. A request for a product or service may be also based on a name or an identification code of a product/service provider, such as a specific toy store, an electronics distributor, or a cleaner. A search request for a product or service may be limited to a geographical area. A desired geographical area may be identified by a shopper's city and state, zip code, and/or a target location. A geographical area may be limited to a proximity range, such as a default or a user-defined search radius about a target location.

After receiving an online search request for providers of a selected product or service, according to one embodiment of the present invention, a search is conducted for both online and offline providers of the desired product or service. In step 104, the database 106, which contains information about online providers, is searched. These “pure-play e-tailers” include those online providers with a Web storefront, which may not have physical retail outlets. They may allow the shoppers to trade with them only through online shopping.

In step 108, the database 110, which contains information about offline providers, is searched. The offline providers may include the offline “brick-&-mortar” providers, which have physical retail outlets but no Web storefront, such as local mom-&-pop stores. The offline providers may also include the offline “click-&-mortar” providers, which have physical retail outlets as well as Web storefront. These offline providers may allow the shoppers to trade with them either online or offline.

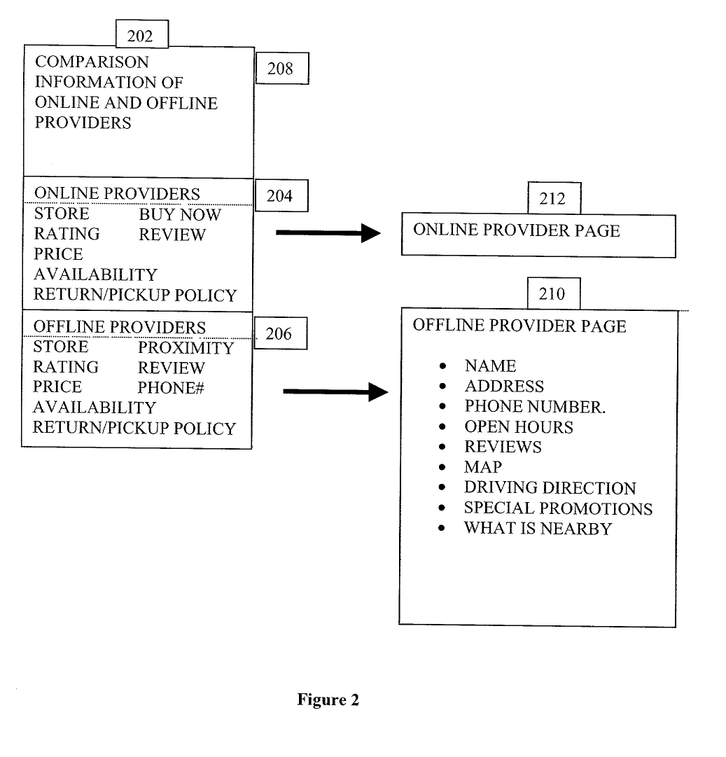

In step 112, the search results for both online and offline providers may be combined to generate an integrated search result for the desired product or service. FIG. 2 presents an exemplary integrated provider page 202. The integrated provider page 202 may include a first portion 204, pertaining to the online providers that carry the desired product/service, and a second portion 206, pertaining to the offline providers that carry the same product or service.

In step 114, the online providers of a desired product or service may be compared to the offline providers of such product or service. The provider page 202 may also include a third portion 208 that may provide comparison information about online and offline providers of a selected product or service. The comparison information may be based on providers rating, a product/service price, product/service availability, user review, professional/expert review, and special promotions, such as coupons and/or sales, and/or return/pickup policies. Therefore, the bargain-seeker, price-driven, and sales-fanatic shoppers may conveniently get the providers comparison information online, and may do more online shopping confidently. This attracts more shoppers to do online shopping, attracts more “brick-&-mortar” offline providers to join online shopping services, and retains more “pure-play e-tailer” online providers.

The list of offline providers of a product or service may be based on a target geographical location. Shoppers may choose such target locations to be their home, work, or other locations. A shopper may choose one of several target locations, which may have been already created and stored for future use.

The comparison information may also include comparison information about the offline providers of a selected product or service, which may be based on information such as proximity to a target location, price, rating, special promotions, product/service availability, or user and/or expert review. The list of offline providers may be prioritized based on a desired factor, such as proximity to a target location, price, rating, or user and/or expert review. When an online shopper selects an offline product service provider from a provider page 206, the shopper may receive detailed information about the selected offline provider.

The provider page 202 may contain a direct link to an offline provider page 210 that may provide detailed information for a selected offline provider. Such detailed information may include a provider's business name, address, phone number, photo, map, working hours, rating, user and/or expert reviews, driving direction, sales and/or coupons, and in-store pickup and/or return policies of online purchases. The offline providers may regularly update their information. The provider page 202 may also contain a direct link to an online provider page 212, which may provide detailed information about a selected online provider and/or a product or service page.

In another embodiment of the invention, a provider locator allows searching for a desired provider, which may include an A-Z directory of providers, a directory of product/service categories, and/or a provider department page.

The method and system of the invention creates a comparison shopping experience that enables online shoppers to shop online confidently and conveniently, knowing that they are getting the best deal for a product/service based on online comparison information about online and offline product/service providers. The system and method of the present invention provides a multi-channel search result, an integrated list of online and offline providers, and providers comparison information.

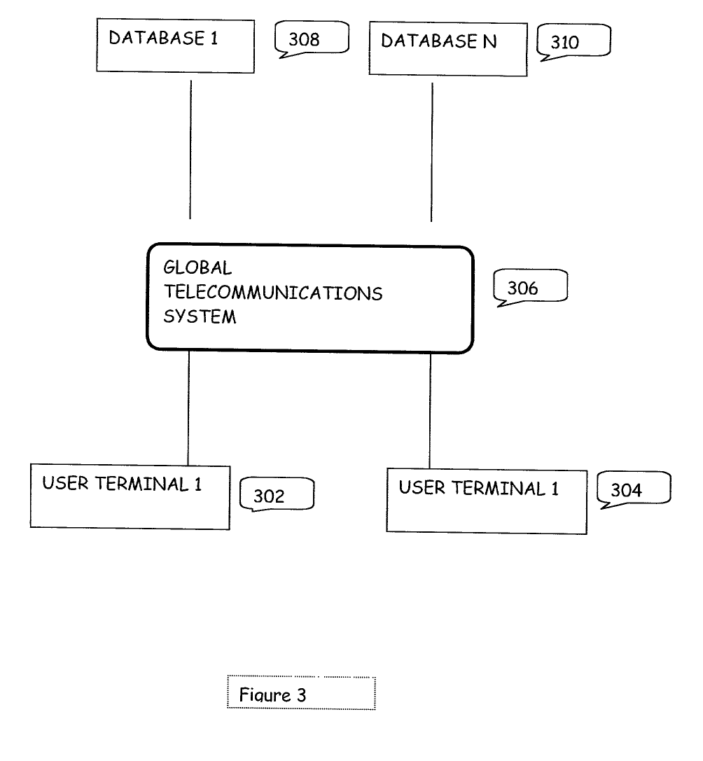

FIG. 3 shows a representation of an exemplary system for providing integrated shopping information according to one embodiment of the invention. The user terminals 302, 304 may include the hardware and software modules to implement the disclosed invention. The user terminals may also include the necessary devices and software modules to connect to the global telecommunication network 306, which may include the Internet. A shopper may use a user terminal to search for shopping information that may be warehoused in the databases 308, 310. The shopping service providers or system managers may regularly update the databases.

Thus, the system and method of the present invention saves shopping time for bargain-seeker shoppers, attracts more physical product/service retail outlets to join online shopping services, and retains the online product/service providers.

Accordingly, although the invention has been described in detail with reference to particular preferred or exemplary embodiments, persons possessing ordinary skill in the art to which this invention pertains will appreciate that various modifications and enhancements may be made without departing from the spirit and scope of the claims that follow.

1. A method for providing an integrated electronic list of providers, comprising the steps of:
determining at least one online provider for an item;
determining at least one offline provider for the item; and
integrating the at least one online provider with the at least one offline provider to provide an integrated list of providers for the item.

2. The method of claim 1, wherein the determining steps follow a request for a product.

3. The method of claim 2, wherein the request is for a product category.

4. The method of claim 2, wherein the request is for a desired geographical area.

5. The method of claim 4, wherein the request is for a predetermined proximity to a target location.

6. The method of claim 1, further including:
providing comparison information for the at least one online provider and the at least one offline provider for the item.

7. The method of claim 6, wherein the comparison information includes price comparison.

8. The method of claim 6, wherein the comparison information includes rating comparison.

9. The method of claim 6, wherein the comparison information includes review comparison.

10. The method of claim 6, wherein the comparison information includes availability comparison.

11. The method of claim 6, wherein the comparison information includes special promotion comparison.

12. The method of claim 6, wherein the comparison information includes electronic wallet comparison.

13. The method of claim 6, wherein the comparison information includes return-policy comparison.

14. The method of claim 1, further providing:
providing comparison information about at least two offline providers.

15. The method of claim 14, wherein the comparison information includes in-store return policy of online purchases.

16. The method of claim 14, wherein the comparison information includes in-store pickup policy of online purchases.

17. The method of claim 14, wherein the comparison information includes special promotions.

18. The method of claim 14, wherein the comparison information includes coupon-availability information.

19. The method of claim 14, wherein the comparison information includes proximity to the at least two offline providers.

20. The method of claim 14, wherein the comparison information includes direction to the at least two offline providers.

21. The method of claim 14, wherein the comparison information includes user review.

22. A computer readable medium embodying a method for providing an integrated electronic list of providers, the method comprising the steps of:
determining at least one online provider for an item;
determining at least one offline provider for the item; and
integrating the at least one online provider with the at least one offline provider to provide an integrated list of providers for the item.

23. A system for online shopping, comprising:
at least one user terminal;
at least one database containing information about online and offline providers;
means for searching the database and for providing an integrated list of online and offline providers in response to a search request for a selected item; and
means for comparing the online and offline providers for the selected item.

24. The computer system of claim 23, further implemented on a network environment.

25. The computer system of claim 24, wherein the network environment further comprising a global communications network.
